(19) United States
(12) Patent Application Publication
(10) Pub. No.: US 2004/0235482 A1
(43) Pub. Date: Nov. 25, 2004

(54) Integrated wireline and wireless service using a common directory number

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/626,677

(22) Filed: Jul. 24, 2003

Related U.S. Application Data
(60) Provisional application No. 60/472,291, filed on May 21, 2003.

(51) Int. Cl. H04Q 7/20

(52) U.S. Cl. 455/445; 455/426.1; 455/552.1

(57) ABSTRACT

The present invention relates to routing incoming calls to a single mobile terminal either through a cellular network or through a wireline network via a terminal adaptor, which is capable of wirelessly communicating with the mobile terminal. As such, the mobile terminal may facilitate traditional cellular calls via the cellular network, or traditional wireline network calls via the terminal adaptor. The mobile terminal is only associated with one directory number, which can be used by a caller regardless of whether the mobile terminal is being supported by the wireline network or the cellular network.

This application claims the benefit of provisional patent application Ser. No. 60/472,291, filed May 21, 2003, the disclosure of which is hereby incorporated by reference in its entirety.

### FIELD OF THE INVENTION

The present invention relates to mobile communications, and in particular to allowing a single mobile terminal, using a single directory number, to communicate over cellular networks as well as the wireline network through supporting wireless interfaces.

### BACKGROUND OF THE INVENTION

Today's telephony users generally have at least one wireline-based telephone receiving services through a wireline network and a mobile telephone receiving services through a cellular network. These wireline and mobile telephones are incompatible, and thus incapable of facilitating communications over both the cellular and public switched networks. As such, telephony users must juggle multiple telephone terminals, using one terminal to make and receive calls via the cellular network, and another to make and receive calls via the wireline network. In addition to the user having to keep track of multiple telephones and directory numbers, calls are generally less expensive through the service providers of the wireline network compared to cellular network. Accordingly, there is a need for a technique to allow a single telephony device to interface with both the cellular network and the wireline network in an effective and efficient manner. There is a need to allow calls to be handled via the wireline network when the telephony device is capable of terminating the incoming call via the wireline network, and terminate the call via the cellular network when termination via the wireline network is not possible, or as desired. There is also a need to reuse as much as possible the existing wireline infrastructure and minimize the changes required to support mobility. There is a further need to avoid having a different directory number associated with the wireline network than is associated with the cellular network.

### SUMMARY OF THE INVENTION

The present invention relates to routing incoming calls to a single mobile terminal either through a cellular network or through a wireline network via a terminal adaptor, which is capable of wirelessly communicating with the mobile terminal. As such, the mobile terminal may facilitate traditional wireless calls via the cellular network, or traditional wireline network calls via the terminal adaptor. The mobile terminal is only associated with one directory number, which can be used by a caller regardless of whether the mobile terminal is being supported by the wireline network or the cellular network.

The terminal adaptor may monitor its ability to communicate with the mobile terminal, and provide such information to a service node, which controls whether incoming calls directed to the mobile terminal are routed through the cellular network or the wireline network. When the mobile terminal is to handle the call through the terminal adaptor, the service node will route incoming calls to the mobile terminal through the wireline network via the terminal adaptor. When the mobile terminal is to handle the call through the cellular network, the service node will route the incoming call to the mobile terminal through the cellular network. Alternatively, the mobile terminal or user can determine whether the incoming calls should be routed via the wireline network or cellular networks, when service from each is available. In one embodiment, a home location register is associated with the wireline network and assists in obtaining a temporary directory number to use when routing calls through the cellular network.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 illustrates a basic registration process for a mobile terminal for service via a wireline switch according to one embodiment of the present invention.

FIG. 3 illustrates the routing of an incoming call for termination via the wireline switch.

FIG. 4 illustrates a basic registration process for a mobile terminal for service via a cellular switch according to one embodiment of the present invention.

FIG. 5 illustrates the routing of an incoming call for termination via the cellular switch.

FIG. 6 provides a communication call flow diagram wherein incoming calls are routed to the mobile terminal via the wireline switch according to one embodiment of the present invention.

FIG. 7 provides a communication call flow diagram wherein incoming calls are routed to the mobile terminal via the cellular switch according to one embodiment of the present invention.

FIG. 8 is a block representation of a terminal adaptor according to one embodiment of the present invention.

FIG. 9 is a block representation of a service node according to one embodiment of the present invention.

FIG. 10 is a block representation of a mobile terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to providing a mobile terminal that is capable of communication via a cellular-based cellular network, as well as via the public switched telephone network (wireline network) through a terminal adaptor. The terminal adaptor is coupled to the wireline network in traditional fashion, and communicates wirelessly with the mobile terminal using local wireless access technology, such as traditional analog and digital cordless technologies, 802.11 wireless local area network technologies, Digital European Cordless Telephone (DECT) technology, and Bluetooth technology. Communications with the cellular network can use any available cellular access technology, such as time division multiple access (TDMA), code division multiple access (CDMA), and orthogonal frequency division multiple access (OFDM). Importantly, the mobile terminal is associated with one directory number for both cellular network access and wireline network access.

In addition to connecting to the wireline network and providing wireless access for the mobile terminal, the terminal adaptor may have a data interface through which the terminal adaptor can communicate with a service node, which controls the routing of incoming calls directed to the mobile terminal. Depending on the configuration, the terminal adaptor, mobile terminal, or the user may determine whether incoming calls are routed through the cellular network or the wireline network, when the mobile terminal is within a zone in which communication via the local wireless access technology is possible. The terminal adaptor can provide information to the service node bearing on whether the mobile terminal is within or outside of the local wireless access communication zone. The service node will take this information and direct incoming calls through the wireline network when the mobile terminal is within the zone and such routing is desired, and direct calls through the cellular network when the mobile terminal is outside of the zone or when cellular network routing is desired. Accordingly, the present invention effectively routes calls through the cellular network or through the wireline network to a terminal adaptor. The cellular network is preferably a cellular network and can be based on technology such as TDMA, CDMA, UMTS, OFDM, and GSM.

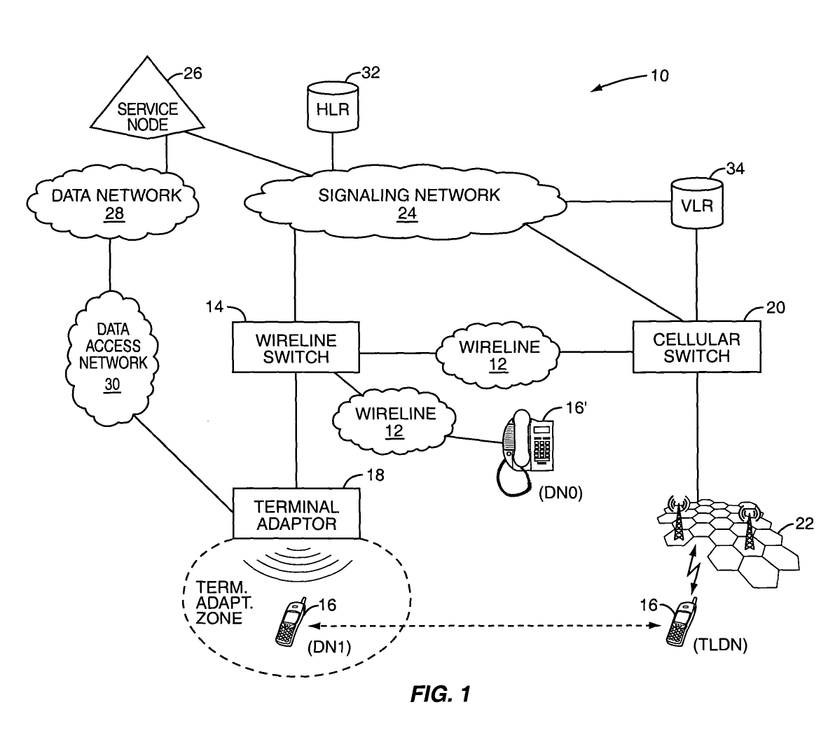

With reference to FIG. 1, a communication environment 10 is illustrated as including a wireline network 12 associated with a wireline switch 14 indirectly supporting a mobile terminal 16, which is associated with a user. For the present invention, the user will have a terminal adaptor 18, which interfaces with the wireline switch 14 and facilitates local wireless communications with the user's mobile terminal 16. Accordingly, for an incoming or outgoing call via the wireline switch 14, the terminal adaptor 18 may provide a circuit-switched interface to the wireline switch 14 and a wireless interface to the mobile terminal 16, wherein the mobile terminal 16 operates analogously to a traditional cordless residential telephone in association with the terminal adaptor 18. Further, the terminal adaptor 18 may be configured to support multiple mobile terminals 16.

The wireline network 12 is also coupled to a cellular switch 20 associated with a cellular network. The cellular switch 20 is coupled to a network of base stations 22 for supporting cellular communications with the mobile terminal 16. Accordingly, the mobile terminal 16 will have multiple modes of operation, wherein one mode facilitates wireless communications via the base stations 22 and another mode facilitates communications with the terminal adaptor 18. In general, communications with the terminal adaptor 18 are of limited range, and are generally referred to as local wireless communications, wherein the communications via the base stations 22 are much broader and limited only to the extent of the cellular network. Call signaling for the wireline network 12 and cellular network is predominantly controlled via a signaling network 24, which may include the Signaling System 7 (SS7) network. For the present invention, a service node 26 is provided in association with the signaling network 24 and is capable of communicating directly or indirectly with both the wireline switch 14 and the cellular switch 20 to gather information pertaining to incoming calls, as well as providing instructions for routing these calls to the mobile terminal 16 through the wireline switch 14 or an appropriate cellular switch 20. Further, the service node 26 may communicate with the terminal adaptor 18 via a data access network 30 and a data network 28, such as the Internet.

The wireless interface provided by the terminal adaptor 18 will have a limited range, and as such, will provide a terminal adaptor zone, which defines an area or range in which local communications between the terminal adaptor 18 and the mobile terminal 16 are possible. The terminal adaptor 18, through a variety of possible techniques, may determine whether the mobile terminal 16 is within the terminal adaptor zone, and provide information bearing on the presence of the mobile terminal 16 through the data access network 30 and any local data access customer premise equipment (CPE) to the service node 26. The data access CPE may be a cable modem, DSL modem, ISDN modem, DS1/E1 termination, fiber termination, or like communication terminal that provides access to the data network 28 via the corresponding cable network, DSL network, or IDSN forming the data access network 30. In an alternative embodiment, the wireline switch 14 can be a packet switch. As such, the terminal adapter 18 would facilitate communications via the data access network 30 instead of via a direct circuit-switched interface.

Alternatively, the terminal adaptor 18 may forward information to the service node 26 to alert the service node 26 that the mobile terminal 16 is within the terminal adaptor zone, that calls should be directed to the mobile terminal 16 via the terminal adaptor 18, or a combination thereof. The routing information may be internally generated by the mobile terminal 16 based on virtually any criteria, as well as instructions provided by the user. The terminal adaptor 18 or the mobile terminal 16 may alone or in combination monitor signal levels, bit error rates, or other indicia indicative of the ability of the terminal adaptor 18 to communicate with the mobile terminal 16. Preferably, communications with the wireline switch 14 use Intelligent Network (IN) signaling, and communications with the terminal adaptor 18 are implemented using the Session Initiation Protocol (SIP); however, those skilled in the art will recognize the applicability of alternative signaling technologies and protocols.

Incoming calls to the wireline network directory number (DN1) associated with the mobile terminal 16 are routed to the wireline switch 14, which is provisioned to access the service node 26 to determine how to further route the call for termination. The service node 26 will receive a message from the wireline switch 14 identifying the directory number (DN1) associated with the called party (user) for the incoming call. From the directory number, the service node 26 will recognize that the directory number is the directory number associated with the mobile terminal 16. The service node 26 will determine whether to route the call to the mobile terminal 16 via the terminal adaptor 18 and wireline switch 14, or via the cellular switch 20. If the call is to be routed to the terminal adaptor 18, the service node 26 will send a message to the wireline switch 14 directing the wireline switch 14 to route the incoming call to the mobile terminal 16 via the terminal adaptor 18. If the service node 26 determines that the incoming call should be routed via the cellular network, the service node 26 will instruct the wireline switch 14 to route the call to the mobile terminal 16 through the cellular network via the cellular switch 20.

In one embodiment of the present invention, a home location register (HLR) 32 is provided in association with the wireline switch 14. The HLR 32 is analogous to HLRs found in cellular networks, and is configured to cooperate with visiting location registers (VLRs) 34 of the cellular network. The interplay between the HLR 32 and the VLRs 34 will allow calls to be directed to the mobile terminal 16 via the wireline switch 14 or the cellular switch 20 without requiring the mobile terminal 16 to be associated with different directory numbers for the different networks. In general, the directory number associated with the mobile terminal 16 is a wireline network directory number. A temporary directory number, which does not need to be known by calling parties, will be provided by the VLR 34 or other entity in the cellular network to assist in routing calls to the mobile terminal 16 via the cellular switch 20.

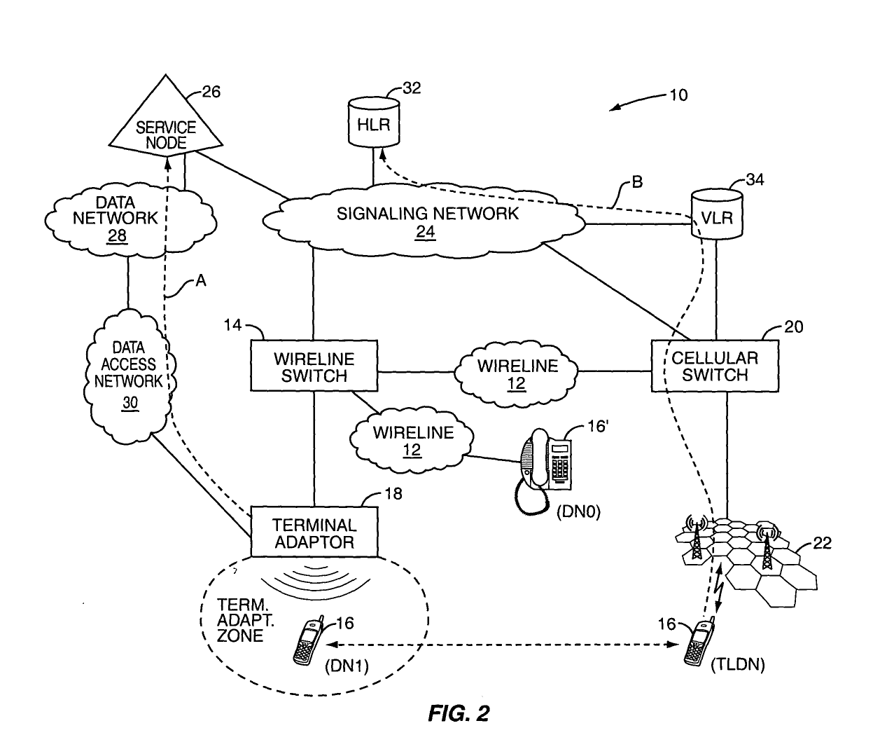

To receive calls via the wireline network 12 through the wireline switch 14 or via the cellular network through the cellular switch 20, the mobile terminal 16 must register its presence with the HLR 32 and the service node 26 as illustrated in FIG. 2. For registration to receive service via the wireline network 12 through the wireline switch 14, registration information is sent to the service node 26 from the terminal adaptor 18 when the mobile terminal 16 enters the terminal adaptor zone (step A). When the mobile terminal 16 moves out of range of the terminal adaptor 18, the terminal adaptor 18 will detect this condition when it no longer can communicate with the mobile terminal 16, and as a consequence will invalidate the registration information in the service node 26 by sending an deregistration message (not illustrated). This way, the service node 26 knows whether it can route calls to the mobile terminal 16 via the terminal adaptor 18 or the cellular switch 20. Given that in most cases the cellular network coverage area provided by the base stations 22 overlaps the smaller terminal adaptor zone, the mobile terminal 16 can also, by enabling permanently or temporarily the cellular network air interface, register with the wireline HLR 32 using standard cellular methods (step B). This way, in the event that a call needs to be routed or handed over from the wireline network 12 to the cellular network, the mobile terminal 16 will already be registered in the cellular network, therefore speeding up the connection setup.

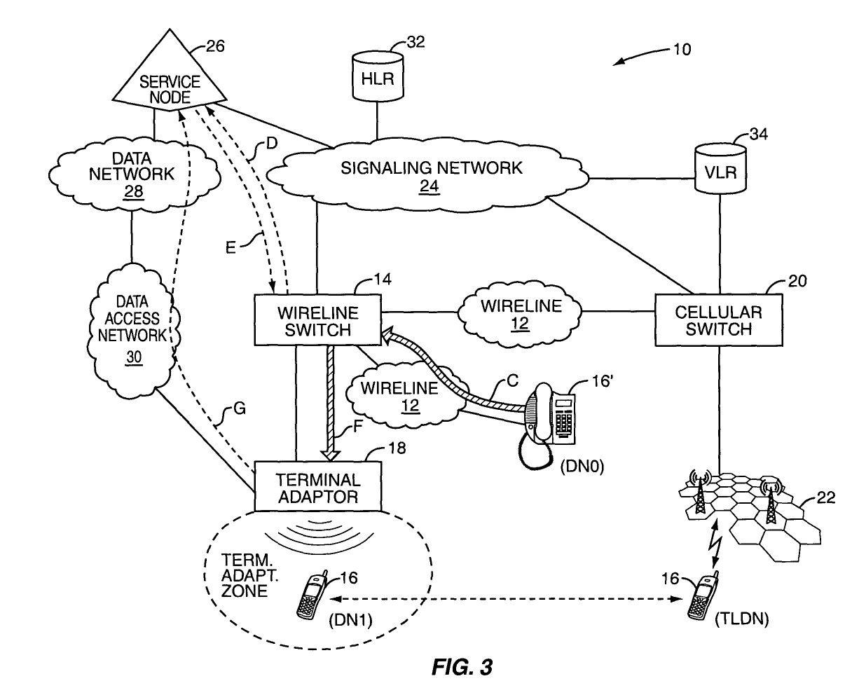

In operation, all incoming calls intended for the mobile terminal 16 are initially routed to the wireline switch 14. It is known by the wireline network 12 and associated networks that the directory number (DN1) is associated with the wireline switch 14. Thus, as illustrated in FIG. 3, when a remote terminal 16′ initiates a call to the mobile terminal 16, the call is initially routed to the wireline switch 14 (step C). The wireline switch 14 is provisioned to send a request to the service node 26 for instructions on how to route the incoming call (step D). Based on the previous registration, the service node 26 will recognize that the incoming call should be directed to the mobile terminal 16 via the terminal adaptor 18, and will provide such instruction to the wireline switch 14 (step E). The wireline switch 14 will then take the necessary steps to connect the incoming call to the terminal adaptor 18 (step F), which will cooperate with the mobile terminal 16 to facilitate bi-directional communications for the parties participating in the call.

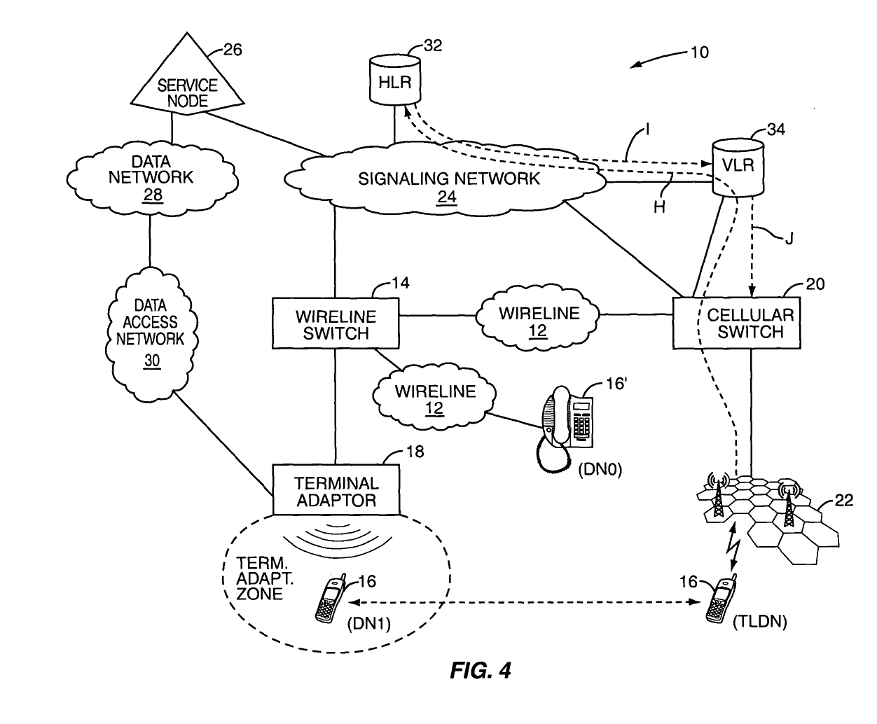

If the mobile terminal 16 moves outside of the local communication range of the terminal adaptor 18, the mobile terminal 16 may signal via the terminal adaptor 18 to the service node 26 that it is about to lose communication and that communication via the cellular network is now preferred. Alternatively, the terminal adapter 18 may detect the loss or the imminent loss of communication with the mobile terminal 16 and will signal to the service node 26 that communication is now preferred via the cellular network (step G). The user of the mobile terminal 16 can also manually force the switch from one access method to the other, and the mobile terminal 16 will signal that choice to the service node 26. As the mobile terminal 16 enters the mode where communication is now preferred via the cellular network, the mobile terminal 16 must ensure to be registered with the local cellular switch 20, the corresponding VLR 34, and the HLR 32. It may already be registered if the mobile terminal 16 was in an area where there was coverage by the cellular network (as illustrated with step B in FIG. 2). Accordingly, as illustrated in FIG. 4, registration for cellular network access may begin with a registration message being sent to the HLR 32 via the cellular switch 20, directly or indirectly via the VLR 34 (step H). Typically, the HLR 32 will receive some form of mobile terminal identification, such as a mobile identification number (MIN). The HLR 32 will send a user profile associated with the mobile terminal 16 to the VLR 34 to support cellular service for the mobile terminal 16 (step 1). The profile may then be forwarded to the cellular switch 20 (step J). At this point, the mobile terminal 16 is registered with the HLR 32, and the service node 26 knows to have incoming calls to directory number DN1 directed to the mobile terminal 16 via the cellular network.

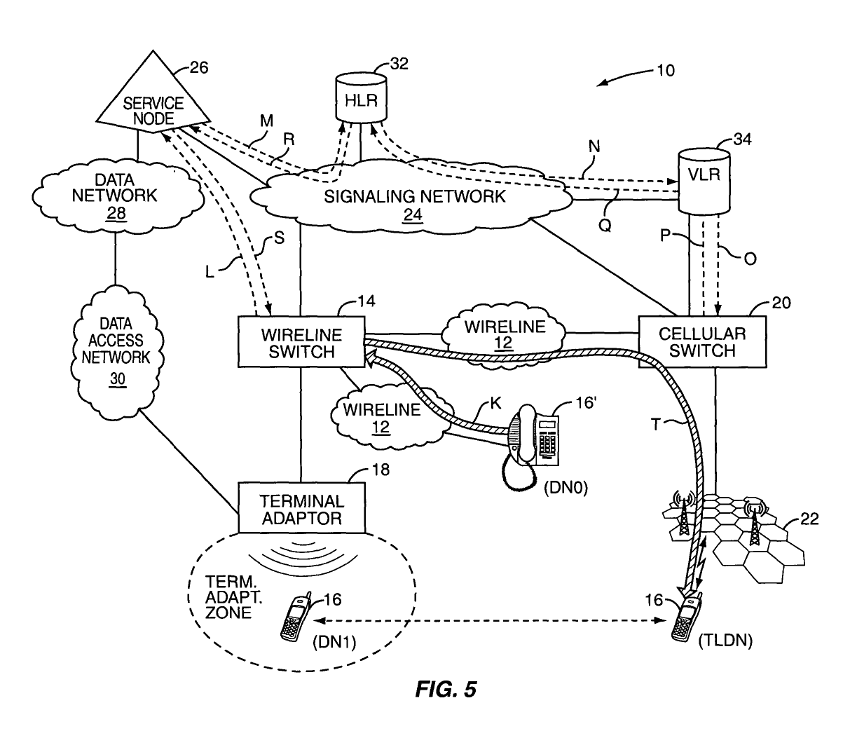

Turning now to FIG. 5, the process of routing a call to the mobile terminal 16 via the cellular network is illustrated. Initially, a call intended for directory number DN1 comes into the wireline switch 14 from telephony terminal 16′ (step K). The wireline switch 14 is provisioned to recognize numbers directed to directory number DN1 and request routing instructions from the service node 26 (step L). The service node 26 will recognize that incoming calls to the mobile terminal 16 should be routed via the cellular network, and will request routing information from the HLR 32 for the mobile terminal 16 (step M). In one embodiment, the routing information is provided in the form of a temporary local directory number (TLDN) provided by the cellular network. Accordingly, the HLR 32 will send a request for a TLDN from the VLR 34 (step N). The VLR 34 will request the TLDN for the mobile terminal 16 from the cellular switch 20 (step O), which will provide the TLDN to the VLR 34 (step P). The VLR 34 will then respond to the HLR 32 with the TLDN (step Q). The HLR 32 will forward the TLDN to the service node 26 (step R), which will send instructions to the wireline switch 14 to route the call to the TLDN (step S). At this point, the wireline switch 14 will route the incoming call to the cellular switch 20, which will facilitate a connection with the mobile terminal 16 via the base station network 22 in traditional fashion (step T).

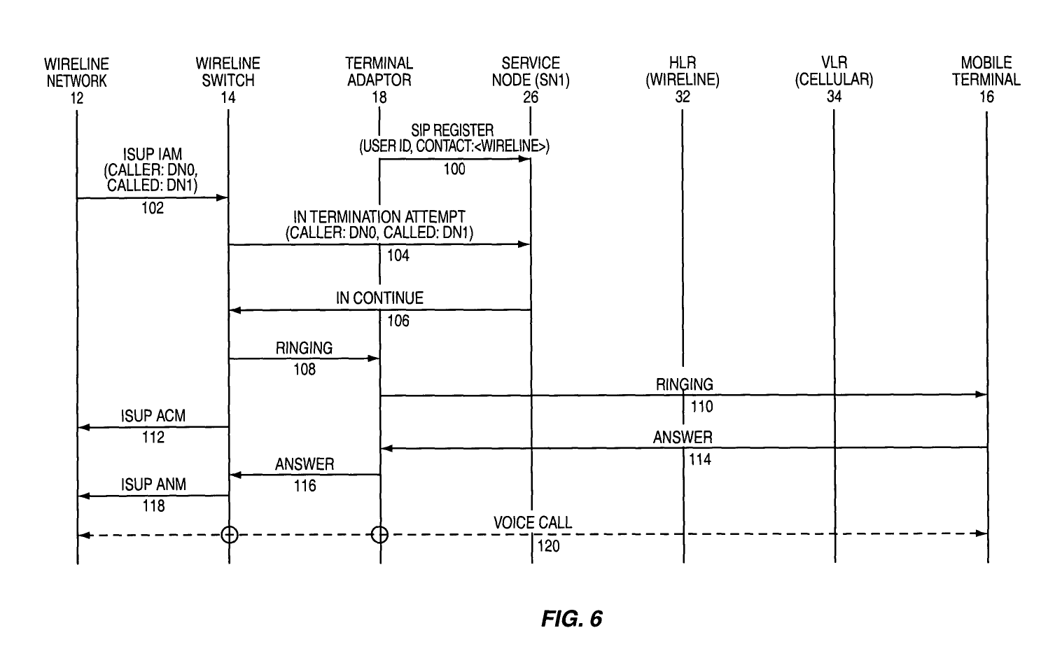

Turning now to FIG. 6, an exemplary communication flow diagram is provided with specific messaging protocols, wherein the Session Initiation Protocol (SIP) is used for communications between the terminal adaptor 18 and the service node 26, Telecom Industry Association (TIA) standard IS-41 for CDMA cellular protocols are used between the service node 26 and entities associated with the call signaling network 24, and Intelligent Network (IN) messaging is used between the wireline network 12 and cellular network. For FIG. 6, a registration process for a mobile terminal 16 to be serviced by the terminal adaptor 18 is provided, followed by a communication flow for routing an incoming call to the mobile terminal 16 via the wireline switch 14.

The registration process begins when either the terminal adaptor 18 recognizes that calls should be routed to the mobile terminal 16 through the terminal adaptor 18, or when the mobile terminal 16 on behalf of a user or on its own initiative instructs the terminal adaptor 18 that such routing is desired. At this point, the terminal adaptor 18 will send a SIP Register message to the service node 26 providing a user ID and instructions for routing calls to the mobile terminal 16 via the terminal adaptor 18 (over a wireline connection) (step 100). At this point, the mobile terminal 16 is registered with the service node 26, and the service node 26 will preferably route incoming calls to the mobile terminal 16 via the wireline network 12.

When an incoming call arrives over the wireline network 12 that is intended for the mobile terminal 16, an Integrated Services User Protocol (ISUP) Initial Address Message (IAM) is received by the wireline switch 14, and identifies the directory numbers of the caller and called party (DN0 and DN1, respectively) (step 102). In this embodiment, the wireline switch 14 is provisioned to send an IN Termination Attempt trigger to the service node 26 identifying the caller and called party (step 104). Because of the registration (in step 100), the service node 26 will recognize that the incoming call needs to be routed via the wireline switch 14, and will send an IN Continue message to the wireline switch 14 (step 106). The wireline switch 14 will proceed in a normal fashion with connecting the incoming call to the mobile terminal 16 via the terminal adaptor 18. Such connection is accomplished by the wireline switch 14 sending a Ringing signal to the terminal adaptor 18 (step 108), which will effect ringing of the mobile terminal 16 (step 110). Next, the wireline switch 14 will send an ISUP Address Complete Message (ACM) back through the wireline network 12 toward the telephony switch originating the incoming call (step 112). At some point, the mobile terminal 16 will be answered, which will trigger an Answer message or signal to be sent back to the terminal adaptor 18 (step 114), which will send an Offhook or other answer signal to the wireline switch 14 (step 116). The wireline switch 14 will then send an ISUP Answer Message (ANM) toward the originating telephony switch for the incoming call (step 118), wherein a voice call is established between the caller and called party via the wireline switch 14 and terminal adaptor 18 (step 120).

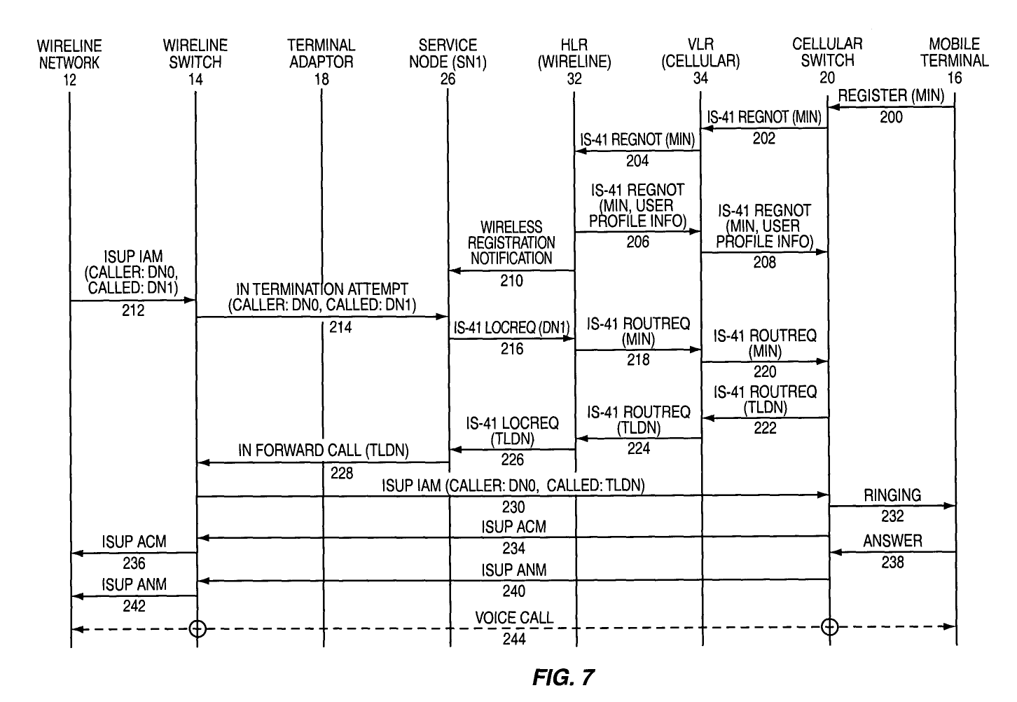

Turning now to FIG. 7, the registration and call completion process for routing calls via the cellular network is provided. Initially, the mobile terminal 16 when in reach of the cellular network will send a Register message with some form of identification indicia, such as the MIN, to the cellular switch 20 (step 200). The cellular switch 20 will send an IS-41 Registration Notification (REGNOT) message to the VLR 34 associated with the cellular switch 20 identifying the mobile terminal 16 (step 202). The VLR 34 will forward the IS-41 REGNOT message to the HLR 32 associated with the mobile terminal 16 (step 204). In response, the HLR 32 will use the MIN to access a user profile for the mobile terminal 16 and will send the user profile information to the VLR 34 (step 206), which will further forward the user profile information to the cellular switch 20, again in a response-based IS-41 REGNOT message (step 208). The HLR 32 may also alert the service node 26 of this registration (step 210). The service node 26 is provisioned to associate the MIN information with directory number DN1. The service node 26 may use this notification to know when it is possible to route incoming calls for DN1 via the cellular network. It is possible for the mobile terminal 16 to be unreachable via the wireline network 12 or the cellular network, for example if the mobile terminal 16 is turned off or currently in an area with poor wireless coverage. If no registration from the cellular network has been received, the service node 26 may instruct the wireline switch 14 to forward the call directly to voicemail. At this point, the service node 26 and the HLR 32 are aware that the mobile terminal 16 is being serviced by the cellular switch 20 associated with the VLR 34, and the cellular switch 20 has the appropriate user profile, including any services available to the mobile terminal 16 through the cellular network.

Incoming calls for the mobile terminal 16 are directed to directory number DN1, and as such, will be received by the wireline switch 14. In this example, the wireline switch 14 will receive an ISUP IAM indicating an incoming call to the mobile terminal 16 is being received from a caller associated with directory number DN0 (step 212). The wireline switch 14 is again provisioned to send an IN Termination Attempt trigger to the service node 26 to alert the service node 26 of the incoming call directed to the mobile terminal 16 (step 214). The service node 26 may send an IS-41 Location Request (LOCREQ) message to the HLR 32 to ascertain where the incoming call should be routed (step 216), wherein the LOCREQ message will identify the directory number for the mobile terminal 16. Based on the previous registration, the HLR 32 will recognize that routing information must be retrieved from the VLR 34, and as such, will send an IS-41 Route Request (ROUTREQ) message or similar message to the proper VLR 34 (step 218). The route request message may include the MIN for the mobile terminal 16. The VLR 34 will then send an IS-41 ROUTREQ message to the cellular switch 20 with the MIN to retrieve a TLDN to which incoming calls to the mobile terminal 16 will be routed (step 220). Thus, the cellular switch 20 will provide an appropriate TLDN to the VLR 34 (step 222), which will forward the TLDN to the HLR 32 (step 224) in respective response-based IS-41 ROUTREQ messages. The HLR 32 at this point will have the TLDN for the mobile terminal 16 in the cellular network, and will respond to the LOCREQ (see step 216) with a response-based IS-41 LOCREQ including the TLDN (step 226).

At this point, the service node 26 will recognize that the incoming call should be routed to the mobile terminal 16 via the cellular network based on the response to the location request, and as such, will send a message to the wireline switch 14 to route the call to the TLDN (step 228). These routing instructions from the service node 26 may come in the form of an IN Forward Call message, which identifies the TLDN to the wireline switch 14. The wireline switch 14 will respond by sending an ISUP IAM through the wireline network 12 and any intermediate switching entities to the cellular switch 20 (step 230). The cellular switch 20 will initiate ringing of the mobile terminal 16 (step 232), as well as send an ISUP ACM back to the wireline switch 14 (step 234), which will forward the ISUP ACM to the telephony switch originating the incoming call in the wireline network 12 (step 236). When the mobile terminal 16 is answered (step 238), the cellular switch 20 will send an ISUP ANM back to the wireline switch 14 (step 240), which will forward the ISUP ANM over the wireline network 12 toward the switch originating the call (step 242). A voice call is then established between the caller and the called party via the cellular network instead of the terminal adaptor 18 (step 244). In this scenario, a user can have both wireline service and cellular service via a single mobile terminal 16 using a single directory number. Those skilled in the art will recognize that the telephony switches, wireline switch 14 and cellular switch 20, can be based on Time Division Multiplex (TDM) or packet technology. The wireline switch 14 can also be a Private Branch Exchange (PBX). In one embodiment, the wireline switch 14 provides a direct user interface to a user via a traditional telephony line, based on analog or digital technology, and can carry one or many simultaneous calls.

The service node 26 may also have the ability to perform rule-based or dynamic call routing in addition to the basic call routing as described in FIGS. 6 and 7. The basic notions of rule-based or dynamic call routing are described in U.S. application Ser. No. 10/382,247 filed Mar. 5, 2003 and U.S. application Ser. No. 10/443,369 filed May 22, 2003, the disclosures of which are hereby incorporated by reference in their entireties. When the service node logic requires routing via the cellular network, the interaction described in FIG. 7 can be used to provide to the service node 26 the TLDN of the mobile terminal 16 in the cellular network. The service node 26 can then instruct the wireline switch 14 to route the call to that TLDN to attempt to reach the mobile terminal 16 in the cellular network.

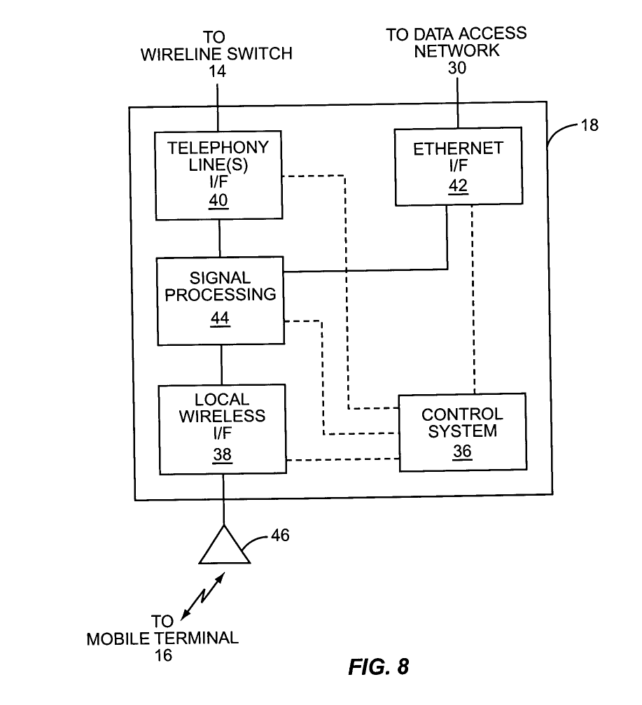

A block representation of the terminal adaptor 18 is provided in FIG. 8. Preferably, the terminal adaptor 18 will include a control system 36 operatively associated with a local wireless interface 38, one or more telephony line interfaces 40, an Ethernet interface 42, and a signal processing function 44. The signal processing function 44 is part of the control system 36, and is capable of providing all the necessary coding, decoding, and conversions necessary for either of the telephony line interface 40 and Ethernet interface 42 to operate with the local wireless interface 38. The local wireless interface 38 is associated with an antenna 46, and is configured to communicate wirelessly with the mobile terminal 16 using any applicable wireless technology, such as traditional analog or digital cordless technology, wireless local area network technology, including 802.11-based technologies, DECT and Bluetooth technology. Clearly, the mobile terminal 16 must be equipped with a compatible interface and be configured to cooperate with the terminal adaptor 18 to facilitate normal telephone operation. As such, the terminal adaptor 18 and the mobile terminal 16 must cooperate such that the mobile terminal 16 knows when to ring, the terminal adaptor 18 knows when the mobile terminal 16 has been answered or ends a call, and the mobile terminal 16 receives any caller identification or like messaging intended for the user or necessary by the mobile terminal 16 for operation. Further, the local wireless interface 38, alone or in conjunction with the control system 36, may be able to periodically or continuously detect whether the mobile terminal 16 is within communication range, and thus within the terminal adaptor zone. Those skilled in the art will recognize numerous techniques for the mobile terminal 16 and terminal adaptor 18 to cooperate with one another to determine whether or not communications are possible or desired, based on analysis or user input via the mobile terminal 16.

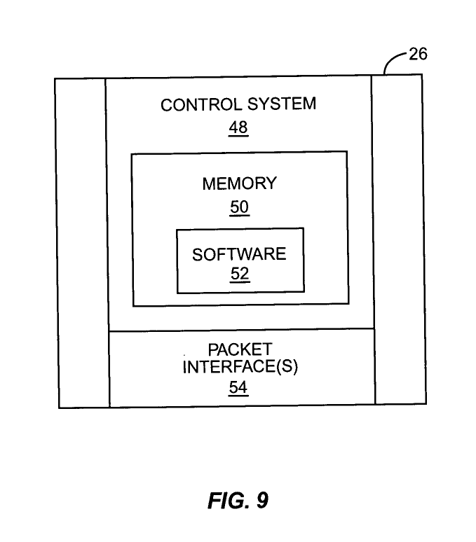

Turning now to FIG. 9, a block diagram of a service node 26 is illustrated. The service node 26 may include a control system 48 having sufficient memory 50 to store the software 52 necessary for operation as described above. The control system 48 is also associated with one or more packet interfaces 54 to facilitate communications with the terminal adaptor 18 via the data network 30, as well as directly or indirectly with the wireline switch 14, cellular switch 20, and HLR 32.

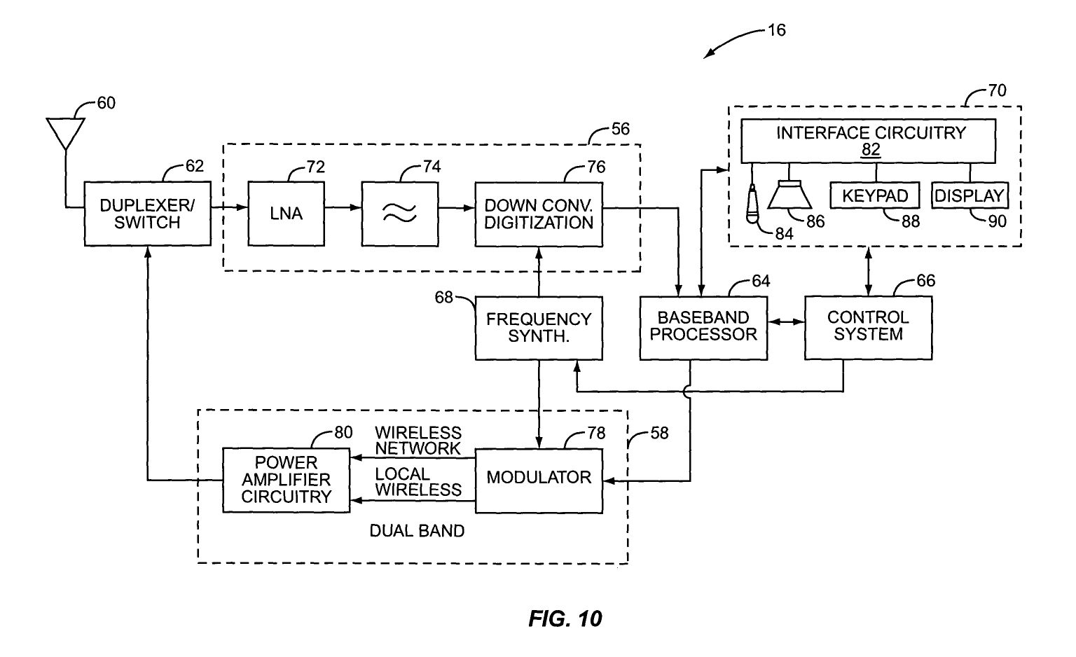

The basic architecture of the mobile terminal 16 is represented in FIG. 10 and may include a receiver front end 56, a radio frequency transmitter section 58, an antenna 60, a duplexer or switch 62, a baseband processor 64, a control system 66, a frequency synthesizer 68, and an interface 70. The receiver front end 56 receives information bearing radio frequency signals from one or more remote transmitters provided by a base station. A low noise amplifier 72 amplifies the signal. A filter circuit 74 minimizes broadband interference in the received signal, while downconversion and digitization circuitry 76 downconverts the filtered, received signal to an intermediate or baseband frequency signal, which is then digitized into one or more digital streams. The receiver front end 56 typically uses one or more mixing frequencies generated by the frequency synthesizer 68. The baseband processor 64 processes the digitized received signal to extract the information or data bits conveyed in the received signal. This processing typically comprises demodulation, decoding, and error correction operations. As such, the baseband processor 64 is generally implemented in one or more digital signal processors (DSPs).

On the transmit side, the baseband processor 64 receives digitized data, which may represent voice, data, or control information, from the control system 66, which it encodes for transmission. The encoded data is output to the transmitter 58, where it is used by a modulator 78 to modulate a carrier signal that is at a desired transmit frequency. Power amplifier circuitry 80 amplifies the modulated carrier signal to a level appropriate for transmission, and delivers the amplified and modulated carrier signal to the antenna 60 through the duplexer or switch 62.

As noted above, the mobile terminal 16 must be able to communicate with the terminal adaptor 18 as well as with the cellular network. Accordingly, the receiver front end 56, baseband processor 64, and radio frequency transmitter section 58 cooperate to provide either a wireless interface for the cellular network or the local wireless interface for the terminal adaptor 18. These functions may be implemented using redundant circuitry, or by configuring common circuitry to operate in different modes. The configuration of the mobile terminal 16 will be dictated by economics and designer choice.

A user may interact with the mobile terminal 16 via an interface 70, which may include interface circuitry 82 associated with a microphone 84, a speaker 86, a keypad 88, and a display 90. The interface circuitry 82 typically includes analog-to-digital converters, digital-to-analog converters, amplifiers, and the like. Additionally, it may include a voice encoder/decoder, in which case it may communicate directly with the baseband processor 64. The microphone 84 will typically convert audio input, such as the user's voice, into an electrical signal, which is then digitized and passed directly or indirectly to the baseband processor 64. Audio information encoded in the received signal is recovered by the baseband processor 64, and converted by the interface circuitry 82 into an analog signal suitable for driving the speaker 86. The keypad 88 and display 90 enable the user to interact with the mobile terminal 16, input numbers to be dialed, address book information, or the like, as well as monitor call progress information. For additional information, please see U.S. application Ser. No. 10/409,280 filed Apr. 8, 2003, U.S. application Ser. No. 10/409,290 filed Apr. 8, 2003, U.S. application Ser. No. 60/472,277 filed May 21, 2003, and U.S. application Ser. No. 60/472,152 filed May 21, 2003, the disclosures of which are incorporated herein by reference in their entireties.

Those skilled in the art will recognize improvements and modifications to the preferred embodiments of the present invention. All such improvements and modifications are considered within the scope of the concepts disclosed herein and the claims that follow.

What is claimed is:

1. A method comprising:
a) determining whether to route an incoming call intended for a directory number supported by a wireline switch to a mobile terminal via a terminal adaptor operatively associated with the wireline switch or to the mobile terminal via a cellular network;
b) when determining the incoming call should be routed via the terminal adaptor, instructing the wireline switch to route the incoming call to the mobile terminal via the terminal adaptor; and
c) when determining the incoming call should be routed via the cellular network, instructing the wireline switch to route the incoming call to the mobile terminal via the cellular network using a temporary routing indicia, which is temporarily associated with the mobile terminal to facilitate routing the incoming call to the mobile terminal via the cellular network.

2. The method of claim 1 wherein the temporary routing indicia is a temporary directory number provided by the cellular network and used to route the incoming call to a cellular switch currently supporting the mobile terminal.

3. The method of claim 1 further comprising accessing routing information and determining whether to route the incoming call via the terminal adaptor or the cellular network based on the routing information.

4. The method of claim 3 wherein the routing information comprises the temporary routing indicia when the incoming call should be routed via the cellular network.

5. The method of claim 4 wherein the home location register obtains the temporary routing indicia from a visiting location register, which is associated with a cellular switch supporting the mobile terminal.

6. The method of claim 3 wherein the routing information comprises first information relating to the directory number when the incoming call should be routed via the terminal adaptor.

7. The method of claim 1 wherein the mobile terminal is not permanently associated with a dedicated directory number for the cellular network and is only associated with the directory number.

8. The method of claim 1 further comprising receiving from the wireline switch a first message indicative of an incoming call intended for the directory number.

9. The method of claim 1 wherein the directory number is assigned to a telephony line associated with the terminal adaptor.

10. The method of claim 1 wherein instructing the wireline switch to route the incoming call to the mobile terminal via the terminal adaptor further comprises instructing the wireline switch to continue processing the incoming call using the directory number to effect a connection with the mobile terminal via the terminal adaptor.

11. The method of claim 1 wherein instructing the wireline switch to route the incoming call to the mobile terminal via the cellular network using the temporary routing indicia further comprises instructing the wireline switch to forward the incoming call using the temporary routing indicia to effect a connection with the mobile terminal via the cellular network.

12. The method of claim 1 further comprising receiving registration information from the terminal adaptor or the mobile terminal indicating incoming calls should be routed via the terminal adaptor.

13. The method of claim 1 further comprising receiving deregistration information from the terminal adaptor or the mobile terminal indicating incoming calls should be routed via the cellular network.

14. The method of claim 1 further comprising:
a) providing a home location register, which is associated with the wireline switch; and
b) receiving at the home location register, registration information from the cellular network indicating incoming calls to the mobile terminal can be routed via the cellular network.

15. The method of claim 14 wherein the registration information is received from a visiting location register associated with the cellular network.

16. The method of claim 1 wherein the terminal adaptor and the mobile terminal are adapted to communicate using local wireless communications.

17. The method of claim 16 where the local wireless communications are effected using one of 802.11, DECT, Bluetooth, and analog cordless technologies.

18. The method of claim 1 where the cellular network is based on one of GSM, CDMA, UMTS, TDMA, and analog cellular technologies.

19. A system comprising:
a) at least one communication interface; and
b) a control system associated with the at least one communication interface and adapted to:
i) determine whether to route an incoming call intended for a directory number supported by a wireline switch to a mobile terminal via a terminal adaptor operatively associated with the wireline switch or to the mobile terminal via a cellular network;
ii) when the incoming call should be routed via the terminal adaptor, instruct the wireline switch to route the incoming call to the mobile terminal via the terminal adaptor; and
iii) when the incoming call should be routed via the cellular network, instruct the wireline switch to route the incoming call to the mobile terminal via the cellular network using a temporary routing indicia, which is temporarily associated with the mobile terminal to facilitate routing the incoming call to the mobile terminal via the cellular network.

20. The system of claim 19 wherein the temporary routing indicia is a temporary directory number provided by the cellular network and used to route the incoming call to a cellular switch currently supporting the mobile terminal.

21. The system of claim 18 wherein the control system is further adapted to access routing information and determine whether to route the incoming call via the terminal adaptor or the cellular network based on the routing information.

22. The system of claim 20 wherein the routing information comprises the temporary routing indicia when the incoming call should be routed via the cellular network.

23. The system of claim 22 wherein the temporary routing indicia is accessed from a visiting location register, which is associated with a cellular switch supporting the mobile terminal.

24. The system of claim 21 wherein the routing information comprises first information relating to the directory number when the incoming call should be routed via the terminal adaptor.

25. The system of claim 19 wherein the mobile terminal is not permanently associated with a dedicated directory number for the cellular network and is only associated with the directory number.

26. The system of claim 19 wherein the control system is further adapted to receive from the wireline switch a first message indicative of an incoming call intended for the directory number.

27. The system of claim 19 wherein the directory number is assigned to a telephony line associated with the terminal adaptor.

28. The system of claim 19 wherein to instruct the wireline switch to route the incoming call to the mobile terminal via the terminal adaptor, the control system is further adapted to instruct the wireline switch to continue processing the incoming call using the directory number to effect a connection with the mobile terminal via the terminal adaptor.

29. The system of claim 19 wherein to instruct the wireline switch to route the incoming call to the mobile terminal via the cellular network using the temporary routing indicia, the control system is further adapted to instruct the wireline switch to forward the incoming call using the temporary routing indicia to effect a connection with the mobile terminal via the cellular network.

30. The system of claim 19 wherein the control system is further adapted to receive registration information from the terminal adaptor indicating incoming calls should be routed via the terminal adaptor.

31. The system of claim 19 wherein the control system is further adapted to receive deregistration information from the terminal adaptor or the mobile terminal indicating incoming calls should be routed via the cellular network.

32. The system of claim 19 wherein the control system is further adapted to:
a) provide a home location register, which is associated with the wireline switch; and
b) receive at the home location register, registration information from the cellular network indicating incoming calls to the mobile terminal should be routed via the cellular network.

33. The system of claim 32 wherein the registration information is received from a visiting location register associated with the cellular network.

34. The system of claim 19 wherein the terminal adaptor and the mobile terminal are adapted to communicate using local wireless communications.

35. The system of claim 34 wherein the local wireless communications are effected using one of 802.11, DECT, Bluetooth, and analog cordless.

36. The system of claim 19 wherein the cellular network is based on one of GSM, CDMA, UMTS, TDMA, and analog cellular technologies.
